(19) United States
(12) Patent Application Publication
(10) Pub. No.: US 2024/0304356 A1
(43) Pub. Date: Sep. 12, 2024

(54) ELECTRICAL CABLE WITH IMPROVED THERMAL CONDUCTIVITY

(71) Applicant: NEXANS, COURBEVOLE (FR)

(72) Inventors: Christelle MAZEL, RUY (FR); Gabriele PEREGO, MILAN (IT); Daphné MERLE, VENISSIEUX (FR); Claire GRANGER, VAUX-EN-VELIN (FR)

(21) Appl. No.: 18/275,402

(22) PCT Filed: Feb. 2, 2022
(86) PCT No.: PCT/FR2022/050194

§ 371 Date: Aug. 1, 2023

(30) Foreign Application Priority Data
Feb. 3, 2021 (FR) 2101019

(51) Int. Cl. H01B 3/44; C08K 5/01; C08K 7/00; C08K 13/02; H01B 3/22; H01B 7/42

(52) U.S. Cl. CPC H01B 3/441; C08K 5/01; C08K 7/00; C08K 13/02; H01B 3/22; H01B 7/428; C08K 2201/001; C08K 2201/005; C08K 2201/006

(57) ABSTRACT

The invention relates to a cable comprising at least one electrically insulating layer obtained from a polymer composition comprising at least one thermoplastic polymer material based on polypropylene, at least one dielectric liquid, at least a first thermally conductive inorganic filler having a morphology M1 and at least a second thermally conductive inorganic filler having a morphology M2 different from M1.

The invention relates to a cable comprising at least one electrically insulating layer obtained from a polymer composition comprising at least one thermoplastic polymer material based on polypropylene, at least one dielectric liquid, at least a first thermally conductive inorganic filler having a morphology M1 and at least a second thermally conductive inorganic filler having a morphology M2 different from M1.

The invention typically but not exclusively applies to electric cables intended for power transmission, notably to medium-voltage (notably from 6 to 45-60 kV) or high-voltage (notably greater than 60 kV, and which can go up to 400 kV) power cables, preferably medium-voltage power cables, whether in direct or alternating current, in the fields of aerial, submarine or terrestrial power transmission.

The invention applies in particular to electric cables with improved thermal conductivity.

A medium-voltage or high-voltage power transmission cable preferably comprises, from the inside to the outside:
an elongated electrically conductive element, notably made of copper or aluminum;
an inner semiconductive layer surrounding said elongated electrically conductive element;
an electrically insulating layer surrounding said inner semiconductive layer;
an outer semiconductive layer surrounding said insulating layer;
optionally an electrical shield surrounding said outer semiconductive layer; and
optionally an electrically insulating protective sheath surrounding said electrical shield.

International patent application WO 2018/167442 A1 discloses an electric cable comprising at least one elongated electrically conductive element and at least one electrically insulating layer obtained from a polymer composition comprising at least one polypropylene-based thermoplastic polymer material, and at least one inorganic filler such as kaolin or chalk. However, the thermal conductivity properties are not optimized.

The aim of the present invention is consequently to overcome the drawbacks of the techniques of the prior art by proposing an electric cable, notably a medium-voltage or high-voltage cable, based on propylene polymer(s), said cable being able to operate at temperatures above 70° C., and having improved thermal conductivity properties, while at the same time ensuring good electrical properties, notably in terms of dielectric strength, and good mechanical properties, notably in terms of elongation at break and tensile strength.

The aim is achieved by the invention which will be described hereinbelow.

A first subject of the invention is an electric cable comprising at least one elongated electrically conductive element and at least one electrically insulating layer obtained from a polymer composition, characterized in that the polymer composition comprises at least one thermoplastic polymer material based on polypropylene, at least one dielectric liquid, at least a first thermally conductive inorganic filler having a morphology M1 and at least a second thermally conductive inorganic filler having a morphology M2 different from the morphology M1 of the first thermally conductive inorganic filler.

The cable of the invention may operate at temperatures above 70° C., and has improved thermal conductivity properties, while ensuring good electrical properties, notably in terms of dielectric strength, and/or good mechanical properties, notably in terms of elongation at break and tensile strength.

The combination of a polypropylene-based thermoplastic polymer material with at least two thermally conductive inorganic fillers of different morphologies M1 and M2 allows an electrically insulating layer with improved thermal conductivity properties to be obtained.

### The First and Second Thermally Conductive Inorganic Fillers

The first thermally conductive inorganic filler [or, respectively, the second thermally conductive inorganic filler] may have a thermal conductivity of at least about 1 W/m·k at 20° C., and preferably of at least about 5 W/m·k at 20° C.

In the present invention, the thermal conductivity is preferably measured according to the well-known Transient Plane Source or TPS method. Advantageously, the thermal conductivity is measured using a device sold under the reference Hot Disk TPS 2500S by the company Thermoconcept.

The first thermally conductive inorganic filler [or, respectively, the second thermally conductive inorganic filler] may be chosen from silicates, boron nitride, carbonates and metal oxides, preferably from silicates, carbonates and metal oxides, and particularly preferably from silicates and metal oxides.

Among the silicates, mention may be made of aluminum, calcium or magnesium silicates, preferably aluminum or magnesium silicates, notably hydrated magnesium silicates.

The aluminum silicates may be chosen from kaolins and any other mineral or clay predominantly comprising kaolinite.

In the present invention, the term “any other mineral or clay predominantly comprising kaolinite” means any other mineral or clay comprising at least about 50% by weight, preferably at least about 60% by weight, and more preferably at least about 70% by weight, of kaolinite, relative to the total weight of the mineral or clay.

Kaolins, in particular calcined kaolin, are preferred as aluminum silicates.

The magnesium silicates may be chosen from sepiolites, palygorskites and attapulgites.

Sepiolites are preferred as magnesium silicates.

Among the carbonates, mention may be made of chalk, calcium carbonate (e.g. aragonite, vaterite, calcite, or a mixture of at least two of the abovementioned compounds), magnesium carbonate, limestone, or any other mineral predominantly comprising calcium carbonate or magnesium carbonate.

In the present invention, the term “any other mineral predominantly comprising calcium carbonate or magnesium carbonate” means any other mineral comprising at least about 50% by weight, preferably at least about 60% by weight, and more preferably at least about 70% by weight, of calcium carbonate or magnesium carbonate, relative to the total weight of the mineral.

Chalk and calcium carbonate are preferred as carbonates.

Among the metal oxides, mention may be made of aluminum oxide, a hydrated aluminum oxide, magnesium oxide, silicon dioxide, or zinc oxide, and preferably aluminum oxide or silicon dioxide.

In the present invention, aluminum oxide, also well known as alumina, is a chemical compound having the formula Al₂O₃.

The hydrated aluminum oxide or hydrated alumina may be an aluminum oxide monohydrate or polyhydrate, and preferably monohydrate or trihydrate.

As examples of aluminum oxide monohydrates, mention may be made of boehmite, which is the gamma polymorph of AlO(OH) or Al₂O₃·H₂O; or diaspore, which is the alpha polymorph of AlO(OH) or Al₂O₃·H₂O.

As examples of aluminum oxide polyhydrates, and preferably trihydrates, mention may be made of gibbsite or hydrargillite, which is the gamma polymorph of Al(OH)₃; bayerite, which is the alpha polymorph of Al(OH)₃; or nordstrandite, which is the beta polymorph of Al(OH)₃.

Hydrated aluminum oxide is also well known as “aluminum oxide hydroxide” or “alumina hydroxide”.

Aluminum oxide is preferred as metal oxide.

The aluminum oxide (or, respectively, magnesium oxide) is preferably a calcined aluminum oxide (or, respectively, a calcined magnesium oxide).

The silicon dioxide is preferably fumed silica.

According to a particularly preferred embodiment of the invention, the first thermally conductive inorganic filler [or, respectively, the second thermally conductive inorganic filler] is chosen from kaolins, chalk, sepiolites and aluminum oxides.

The first thermally conductive inorganic filler [or, respectively, the second thermally conductive inorganic filler] may represent at least about 1% by weight, preferably at least about 2% by weight, particularly preferably at least about 5% by weight, and more particularly preferably at least about 10% by weight, relative to the total weight of the polymer composition.

The first thermally conductive inorganic filler [or, respectively, the second thermally conductive inorganic filler] preferably represents not more than about 40% by weight, particularly preferably not more than about 30% by weight, and more particularly preferably not more than about 25% by weight, relative to the total weight of the polymer composition.

The first thermally conductive inorganic filler [or, respectively, the second thermally conductive inorganic filler] may be in the form of particles ranging in size from about 0.001 to about 3 μm, preferably from about 0.01 to about 2 μm, particularly preferably from about 0.05 to about 1.5 μm, and more particularly preferably from about 0.075 to about 1 μm.

Considering several thermally conductive inorganic filler particles according to the invention, the term “size” represents the size distribution D50, this distribution being conventionally determined by methods that are well known to those skilled in the art.

The size of the thermally conductive particle(s) according to the invention may be determined, for example, by microscopy, notably by scanning electron microscopy (SEM), by transmission electron microscopy (TEM), or by laser diffraction.

The size distribution D50 is preferably measured by laser diffraction, for example using a laser beam diffraction granulometer. The size distribution D50 indicates that 50% by volume of the particle population has an equivalent sphere diameter less than the given value.

The first thermally conductive inorganic filler [or, respectively, the second thermally conductive inorganic filler] may have a specific surface area according to the BET method ranging from about 1 to about 500 m²/g, preferably from about 3 to about 450 m²/g, and particularly preferably from about 5 to about 400 m²/g.

In the present invention, the specific surface area of the thermally conductive inorganic filler may be readily determined according to the standard DIN 9277 (2010).

The first thermally conductive inorganic filler [or, respectively, the second thermally conductive inorganic filler] may be “treated” or “untreated”, and preferably “treated”.

The term “treated thermally conductive inorganic filler” means a thermally conductive inorganic filler that has undergone surface treatment, or in other words, a surface-treated thermally conductive inorganic filler. Said surface treatment notably modifies the surface properties of the thermally conductive inorganic filler, for example to improve the compatibility of the thermally conductive inorganic filler with the thermoplastic polymer material.

In a preferred embodiment, the first thermally conductive inorganic filler of the invention [or, respectively, the second thermally conductive inorganic filler] is silanized, or in other words is treated to obtain a first silanized thermally conductive inorganic filler [or, respectively, to obtain a second silanized thermally conductive inorganic filler].

The surface treatment used to obtain the silanized thermally conductive inorganic filler may be a surface treatment using at least one silane compound (with or without a coupling agent), this type of surface treatment being well known to those skilled in the art.

Thus, the first thermally conductive silanized inorganic filler of the invention [or, respectively, the second thermally conductive silanized inorganic filler of the invention] may comprise siloxane and/or silane groups on its surface. Said groups may be of the vinylsilane, alkylsilane, epoxysilane, methacryloxysilane, acryloxysilane, aminosilane or mercaptosilane type.

The silane compound used to obtain the first thermally conductive silanized inorganic filler [or, respectively, the second thermally conductive silanized inorganic filler] may be chosen from:
alkyltrimethoxysilanes or alkyltriethoxysilanes, for instance octadecyltrimethoxysilane (OdTMS-C18), octyl(triethoxy)silane (OTES-C8), methyltrimethoxysilane, hexadecyltrimethoxysilane,
vinyltrimethoxysilanes or vinyltriethoxysilanes,
methacryloxylsilanes or acryloxysilanes, for instance 3-methacryloxypropylmethyldimethoxysilane, 3-methacryloxypropyltrimethoxysilane, 3-methacryloxypropyltrimethoxysilane, 3-acryloxypropyltrimethoxysilane, and
a mixture thereof.

The second thermally conductive inorganic filler is different from the first thermally conductive inorganic filler in that it has a morphology M2 different from the morphology M1 of the first thermally conductive inorganic filler. The morphology (M1, M2) may be represented by at least one of the parameters chosen from the size (t1, t2), the shape (f1, f2), and the specific surface area (s1, s2).

According to a first embodiment, the first and second thermally conductive inorganic fillers have different sizes (t1, t2).

In this first embodiment:
the first thermally conductive inorganic filler is in the form of particles preferably having a size distribution D50 of not more than about 1.5 μm, particularly preferably not more than about 1 μm, and more particularly preferably not more than about 0.9 μm; and
the second thermally conductive inorganic filler is in the form of particles preferably having a size distribution D50 ranging from about 1 to about 900 μm, particularly preferably ranging from about 10 to about 800 μm, and more particularly preferably ranging from about 20 to about 600 μm,
it being understood that [the D50 of the first thermally conductive inorganic filler minus (−) the D50 of the second thermally conductive inorganic filler] is greater than or equal to 100 nm, and preferably greater than or equal to 200 nm, and particularly preferably greater than or equal to 300 nm.

In this first embodiment, the particles of first and second thermally conductive inorganic fillers are preferably in the form of particle aggregates and/or individual particles.

In this first embodiment, the first thermally conductive inorganic filler is preferably chosen from metal oxides, and particularly preferably from aluminum oxides, and the second thermally conductive inorganic filler is preferably chosen from metal oxides, and particularly preferably from aluminum oxides and magnesium oxides.

According to a second embodiment, the first and second thermally conductive inorganic fillers have different shapes (f1, f2), in particular chosen from spherical, particle aggregate (e.g. of various non-elongated shapes), elongated (e.g. in the form of fibers, rods, or wires), flat, and elongated and flat shapes.

In this second embodiment:
the first thermally conductive inorganic filler may be in the form of spherical particles or in the form of particle aggregates; and
the second thermally conductive inorganic filler may be in the form of fibers, notably fibers with a length of between 200 and 2000 nm, a width of between 10 and 30 nm and a thickness of between 5 and 10 nm.

A particle may be defined by a length L and two dimensions D_{A} and D_{B} orthogonal to the length L, with L≥(D_{A}, D_{B}). L generally denotes the largest dimension of the particle. The term “form factor” means the ratio between the length L of a particle and one of the two orthogonal dimensions (D_{A}, D_{B}) of said particle. In the case of a spherical particle, L=D_{A}=D_{B}=diameter of the sphere. In the case of an elongated particle, L>>(D_{A}, D_{B}). In the case of a flat particle, D_{A}<<(L, D_{B}) or D_{B}<<(L, D_{A}).

In this second embodiment:
the first thermally conductive inorganic filler is more particularly in the form of particles having a form factor L₁/D_{A1} or L₁/D_{B1} of not more than 3, and more particularly preferably ranging from 1 to 2; and
the second thermally conductive inorganic filler is more particularly in the form of particles having a form factor L₂/D_{A2} or L₂/D_{B2} of at least 4, and particularly preferably ranging from 5 to 200.

In this second embodiment, the first thermally conductive inorganic filler is preferably chosen from metal oxides, and particularly preferably from aluminum oxides, and the second thermally conductive inorganic filler is preferably chosen from silicates, and particularly preferably from magnesium silicates.

According to a third embodiment, the first and second thermally conductive inorganic fillers have different specific surface areas (s1, s2).

In this third embodiment:
the first thermally conductive inorganic filler preferably has a specific surface area according to the BET method ranging from about 1 to about 300 m²/g, particularly preferably ranging from about 3 to about 200 m²/g, and more particularly preferably ranging from about 5 to about 50 m²/g; and
the second thermally conductive inorganic filler preferably has a specific surface area according to the BET method ranging from about 80 to about 500 m²/g, particularly preferably ranging from about 100 to about 450 m²/g, and more particularly preferably ranging from about 150 to about 400 m²/g,
it being understood that [the specific surface area of the second thermally conductive inorganic filler minus (−) the specific surface area of the first thermally conductive inorganic filler] is greater than or equal to 100 ²/g, preferably greater than or equal to 150 m²/g, and particularly preferably greater than or equal to 200 m²/g.

In this third embodiment, the first thermally conductive inorganic filler is preferably chosen from metal oxides, and particularly preferably from aluminum oxides and magnesium oxides, and the second thermally conductive inorganic filler is preferably chosen from silicates, and particularly preferably from magnesium and aluminum silicates.

The first, second and third embodiments as defined below may be combined with each other. In other words, the first and second thermally conductive inorganic fillers may differ in their size, shape and specific surface area.

The first and second thermally conductive inorganic fillers may be of the same or of different chemical composition. The chemical composition of the filler may influence its morphology.

The mass ratio of first thermally conductive inorganic filler to second thermally conductive inorganic filler is preferably from 0.1 to 9 and particularly preferably from 0.25 to 4.

In one implementation example according to the invention:
the first thermally conductive inorganic filler is chosen from metal oxides such as alumina and silica, in particular calcined alumina. It is in the form of spherical particles, or in the form of particle aggregates, in particular in the form of particle aggregates. It has a mean particle size D50 of between 200 and 600 nm, notably between 300 and 500 nm. It has a specific surface area according to the BET method of less than 100 m²/g, notably between 1 and 50 m²/g, for example between 3 and 25 m²/g, preferably between 5 and 10 m²/g; and
the second thermally conductive inorganic filler is chosen from silicates, such as aluminum, calcium or magnesium silicates, and preferably aluminum or magnesium silicates, in particular hydrated magnesium silicates. It is in the form of elongated particles, in particular fibers, these fibers notably having a length of between 200 and 2000 nm, a width of between 10 and 30 nm and a thickness of between 5 and 10 nm. It has a specific surface area according to the BET method of greater than 100 m²/g, notably between 150 and 450 m²/g, for example between 200 and 400 m²/g, preferably between 250 and 350 m²/g.

### The Dielectric Liquid

The dielectric liquid improves the interface between the inorganic filler and the polypropylene-based thermoplastic polymer material. The presence of the dielectric liquid thus allows improved dielectric properties (i.e. better electrical insulation) to be obtained, and notably improved dielectric strength of the layer obtained from the polymer composition. It may also allow the mechanical properties and/or aging resistance of said layer to be improved.

According to a particular embodiment, the dielectric liquid represents from about 1% to about 20% by weight, preferably from about 2% to about 15% by weight, and particularly preferably from about 3% to about 12% by weight, relative to the total weight of the polymer composition.

The dielectric liquid may comprise at least one liquid chosen from a mineral oil (e.g. naphthenic oil, paraffinic oil or aromatic oil), a plant oil (e.g. soybean oil, linseed oil, rapeseed oil, corn oil or castor oil), a synthetic oil such as an aromatic hydrocarbon (alkylbenzene, alkylnaphthalene, alkylbiphenyl, alkyldiarylethylene, etc.), a silicone oil, an ether oxide, an organic ester, and an aliphatic hydrocarbon, and preferably from a mineral oil (e.g. naphthenic oil, paraffinic oil or aromatic oil), a plant oil (e.g. soybean oil, linseed oil, rapeseed oil, corn oil or castor oil), a synthetic oil such as an aromatic hydrocarbon (alkylbenzene, alkylnaphthalene, alkylbiphenyl, alkyldiarylethylene, etc.), a silicone oil, and an aliphatic hydrocarbon.

The liquid component of the dielectric liquid is generally liquid at about 20-25° C.

The dielectric liquid may comprise at least about 70% by weight of the liquid component of the dielectric liquid, and preferably at least about 80% by weight of the liquid component of the dielectric liquid, relative to the total weight of the dielectric liquid.

Mineral oil is preferred as a liquid component of the dielectric liquid.

The dielectric liquid particularly preferably comprises at least one mineral oil, and at least one polar compound of the benzophenone or acetophenone type, or a derivative thereof.

The mineral oil is preferably chosen from naphthenic oils and paraffinic oils.

The mineral oil is obtained from the refining of a petroleum crude oil.

According to a particularly preferred embodiment of the invention, the mineral oil comprises a paraffinic carbon (Cp) content ranging from about 45 at % to about 65 at %, a naphthenic carbon (Cn) content ranging from about 35 at % to about 55 at %, and an aromatic carbon (Ca) content ranging from about 0.5 at % to about 10 at %.

In a particular embodiment, the polar compound such as benzophenone, acetophenone or a derivative thereof represents at least about 2.5% by weight, preferably at least about 3.5% by weight, and particularly preferably at least about 4% by weight, relative to the total weight of the dielectric liquid. The polar compound can improve the dielectric strength of the electrically insulating layer.

The dielectric liquid may comprise not more than about 30% by weight, preferably not more than about 20% by weight, and even more preferentially not more than about 15% by weight, of a polar compound of the benzophenone or acetophenone type or a derivative thereof, relative to the total weight of the dielectric liquid. This maximum amount ensures moderate or even low dielectric losses (e.g. less than about 10⁻³), and also prevents migration of the dielectric liquid out of the electrically insulating layer.

According to a preferred embodiment of the invention, the polar compound such as benzophenone, acetophenone or a derivative thereof is chosen from benzophenone, dibenzosuberone, fluorenone and anthrone. Benzophenone is particularly preferred.

One or more additives may form part of the constituents of the dielectric liquid or of the polymer composition.

The additives may be chosen from processing aids such as lubricants, compatibilizers, coupling agents, antioxidants, UV stabilizers, antioxidants, anti-copper agents, water-tree-reducing agents, pigments, and a mixture thereof.

The polymer composition may typically comprise from about 0.01% to about 5% by weight, and preferably from about 0.1% to about 2% by weight of additives, relative to the total weight of the polypropylene-based thermoplastic polymer material.

The antioxidants are used for protecting the polymer composition from thermal stresses generated during the steps of manufacturing the cable or when the cable is operating.

The antioxidants are preferably chosen from hindered phenols, thioesters, sulfur-based antioxidants, phosphorus-based antioxidants, amine-type antioxidants, and a mixture thereof.

As examples of hindered phenols, mention may be made of 1,2-bis(3,5-di-tert-butyl-4-hydroxyhydrocinnamoyl)hydrazine (Irganox® MD 1024), pentaerythrityl tetrakis(3-(3,5-di-tert-butyl-4-hydroxyphenyl)propionate (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylenebis[3-(3,5-di-tert-butyl-4-hydroxyphenyl) propionate] (Irganox® 1035) tris(3,5-di-tert-butyl-4-hydroxybenzyl) isocyanurate (Irganox® 3114), 2,2′-oxamidobis(ethyl-3(3,5-di-tert-butyl-4-hydroxyphenyl) propionate) (Naugard XL-1), or 2,2′-methylenebis(6-tert-butyl-4-methylphenol).

As examples of sulfur-based antioxidants, mention may be made of thioethers such as didodecyl 3,3′-thiodipropionate (Irganox® PS800), distearyl thiodipropionate or dioctadecyl 3,3′-thiodipropionate (Irganox® PS802), bis[2-methyl-4-{3-n-(C₁₂ or C₁₄)alkylthiopropionyloxy}-5-tert-butylphenyl] sulfide, thiobis[2-tert-butyl-5-methyl-4,1-phenylene] bis[3-(dodecylthio)propionate], or 4,6-bis(octylthiomethyl)-o-cresol (Irganox® 1520 or Irgastab® KV10).

As examples of phosphorus-based antioxidants, mention may be made of tris(2,4-di-tert-butylphenyl) phosphite (Irgafos® 168) or bis(2,4-di-tert-butylphenyl)pentaerythrityl diphosphite (Ultranox® 626).

As examples of antioxidants of amine type, mention may be made of phenylenediamines (e.g. para-phenylenediamines such as 1PPD or 6PPD), diphenylaminestyrenes, diphenylamines, or 4-(1-methyl-1-phenylethyl)-N-[4-(1-methyl-1-phenylethyl)phenyl]aniline (Naugard 445), mercaptobenzimidazoles, or polymerized 2,2,4-trimethyl-1,2-dihydroquinoline (TMQ).

As examples of antioxidant mixtures that may be used according to the invention, mention may be made of Irganox B 225 which comprises an equimolar mixture of Irgafos 168 and Irganox 1010 as described above.

The antioxidant may represent from about 3% to about 20% by weight, and preferably from about 5% to about 15% by weight, relative to the total weight of the dielectric liquid.

### The Polypropylene-Based Thermoplastic Polymer Material

The polypropylene-based thermoplastic polymer material may comprise a propylene homopolymer or copolymer P₁, and preferably a propylene copolymer P₁.

The propylene homopolymer P₁ preferably has an elastic modulus ranging from about 1250 to 1600 MPa.

In the present invention, the elastic modulus or Young's modulus of a polymer (known as the Tensile Modulus) is well known to those skilled in the art, and may be readily determined according to the standard ISO 527-1, -2 (2012). The standard ISO 527 has a first part, noted “ISO 527-1”, and a second part, noted “ISO 527-2” specifying the test conditions relating to the general principles of the first part of the standard ISO 527.

The propylene homopolymer P₁ may represent at least 10% by weight, and preferably from 15 to 30% by weight, relative to the total weight of the polypropylene-based thermoplastic polymer material.

As examples of propylene copolymers P₁, mention may be made of copolymers of propylene and olefin, the olefin being notably chosen from ethylene and an olefin α₁ other than propylene.

Ethylene or the olefin α₁ other than propylene of the propylene-olefin copolymer preferably represents not more than about 45 mol %, particularly preferably not more than about 40 mol %, and more particularly preferably not more than about 35 mol %, relative to the total number of moles of propylene-olefin copolymer.

The molar percentage of ethylene or olefin α₁ in the propylene copolymer P₁ may be determined by nuclear magnetic resonance (NMR), for example according to the method described in Masson et al., Int. J. Polymer Analysis & Characterization, 1996, Vol. 2, 379-393.

The olefin α₁ other than propylene may have the formula CH₂═CH—R¹, in which R¹ is a linear or branched alkyl group containing from 2 to 12 carbon atoms, notably chosen from the following olefins: 1-butene, 1-pentene, 4-methyl-1-pentene, 1-hexene, 1-octene, 1-decene, 1-dodecene, and a mixture thereof.

Propylene-ethylene copolymers are preferred as the propylene copolymer P₁.

The propylene copolymer P₁ may be a homophasic propylene copolymer or a heterophasic propylene copolymer.

In the invention, the homophasic propylene copolymer P₁ preferably has an elastic modulus ranging from about 600 to 1200 MPa, and particularly preferably ranging from about 800 to 1100 MPa.

Advantageously, the homophasic propylene copolymer P₁ is a statistical propylene copolymer P₁.

Ethylene or the olefin α₁ other than propylene of the homophasic propylene copolymer P₁ preferably represents not more than about 20 mol %, particularly preferably not more than about 15 mol %, and more particularly preferably not more than about 10 mol %, relative to the total number of moles of the homophasic propylene copolymer P₁.

Ethylene or the olefin α₁ other than propylene of the homophasic propylene copolymer P₁ may represent at least about 1 mol %, relative to the total number of moles of homophasic propylene copolymer P₁.

An example of a statistical propylene copolymer P₁ that may be mentioned is the product sold by the company Borealis under the reference Bormed® RB 845 MO or the product sold by the company Total Petrochemicals under the reference PPR3221.

The heterophasic (or heterophase) propylene copolymer P₁ may comprise a thermoplastic propylene phase and a thermoplastic elastomer phase of copolymer of ethylene and an olefin α₂.

The olefin α₂ of the thermoplastic elastomer phase of the heterophasic propylene copolymer P₁ may be propylene.

The thermoplastic elastomer phase of the heterophasic propylene copolymer P₁ may represent at least about 20% by weight, and preferably at least about 45% by weight, relative to the total weight of the heterophasic propylene copolymer P₁.

The heterophasic propylene copolymer P₁ preferably has an elastic modulus ranging from about 50 to about 1200 MPa, and particularly preferably: either an elastic modulus ranging from about 50 to about 550 MPa, and more particularly preferably ranging from about 50 to about 300 MPa; or an elastic modulus ranging from about 600 to about 1200 MPa, and more particularly preferably ranging from about 800 to about 1200 MPa.

As an example of a heterophasic propylene copolymer, mention may be made of the heterophasic propylene copolymer sold by the company LyondellBasell under the reference Adflex® Q 200 F, or the heterophasic copolymer sold by the company LyondellBasell under the reference Moplen EP® 2967.

The propylene homopolymer or copolymer P₁ may have a melting point of greater than about 110° C., preferably greater than about 130° C., particularly preferably greater than about 135° C., and more particularly preferably ranging from about 140 to about 170° C.

The propylene homopolymer or copolymer P₁ may have an enthalpy of fusion ranging from about 20 to 100 J/g.

Preferably, the propylene homopolymer P₁ has an enthalpy of fusion ranging from about 80 to 90 J/g.

The homophasic propylene copolymer P₁ preferably has an enthalpy of fusion ranging from about 40 to 90 J/g, and particularly preferably ranging from 50 to 85 J/g.

The heterophasic propylene copolymer P₁ preferably has an enthalpy of fusion ranging from about 20 to 50 J/g.

The propylene homopolymer or copolymer P₁ may have a melt flow index ranging from 0.5 to 3 g/10 min; notably determined at about 230° C. with a load of about 2.16 kg according to the standard ASTM D1238-00, or the standard ISO 1133.

The homophasic propylene copolymer P₁ preferably has a melt flow index ranging from 1.0 to 2.75 g/10 min, and more preferably ranging from 1.2 to 2.5 g/10 min; notably determined at about 230° C. with a load of about 2.16 kg according to the standard ASTM D1238-00, or the standard ISO 1133.

The heterophasic propylene copolymer P₁ may have a melt flow index ranging from about 0.5 to 3 g/10 min, and preferably ranging from about 0.6 to 1.2 g/10 min; notably determined at about 230° C. with a load of about 2.16 kg according to the standard ASTM D1238-00, or the standard ISO 1133.

The propylene homopolymer or copolymer P₁ may have a density ranging from about 0.81 to about 0.92 g/cm³; notably determined according to the standard ISO 1183A (at a temperature of 23° C.).

The propylene copolymer P₁ preferably has a density ranging from 0.85 to 0.91 g/cm³ and particularly preferably ranging from 0.87 to 0.91 g/cm³; notably determined according to the standard ISO 1183A (at a temperature of 23° C.).

The polypropylene-based thermoplastic polymer material may comprise several different propylene copolymers P₁, notably two different propylene copolymers P₁, said propylene copolymers P₁ being as defined above.

In particular, the polypropylene-based thermoplastic polymer material may comprise a homophasic propylene copolymer (as a first propylene copolymer P₁) and a heterophasic propylene copolymer (as a second propylene copolymer P₁), or two different heterophasic propylene copolymers, and preferably one homophasic propylene copolymer and one heterophasic propylene copolymer.

When the polypropylene-based thermoplastic polymer material comprises a homophasic propylene copolymer and a heterophasic propylene copolymer, said heterophasic propylene copolymer preferably has an elastic modulus ranging from about 50 to 300 MPa.

According to one embodiment of the invention, the two heterophasic propylene copolymers have a different elastic modulus. Preferably, the polypropylene-based thermoplastic polymer material comprises a first heterophasic propylene copolymer having an elastic modulus ranging from about 50 to about 550 MPa, and particularly preferably ranging from about 50 to about 300 MPa; and a second heterophasic propylene copolymer having an elastic modulus ranging from about 600 to about 1200 MPa, and more particularly preferably ranging from about 800 to about 1200 MPa.

Advantageously, the first and second heterophasic propylene copolymers have a melt flow index as defined in the invention.

These combinations of propylene copolymers P₁ may advantageously allow the mechanical properties of the electrically insulating layer to be improved. In particular, the combination affords optimized mechanical properties for the electrically insulating layer, notably in terms of elongation at break, and flexibility; and/or allows a more homogeneous electrically insulating layer to be formed, and notably favors the dispersion of the dielectric liquid in the polypropylene-based thermoplastic polymer material of said electrically insulating layer.

According to a preferred embodiment of the invention, the propylene copolymer P₁ or the propylene copolymers P₁ when more than one is present, represent at least about 50% by weight, preferably from about 55% to 90% by weight, and particularly preferably from about 60% to 90% by weight, relative to the total weight of the polypropylene-based thermoplastic polymer material.

The homophasic propylene copolymer P₁ may represent at least 20% by weight, and preferably from 30% to 70% by weight, relative to the total weight of the polypropylene-based thermoplastic polymer material.

The heterophasic propylene copolymer P₁ or the heterophasic propylene copolymers P₁ when more than one is present may represent from about 5% to 95% by weight, preferably from about 50% to 90% by weight, and particularly preferably from about 60% to 80% by weight, relative to the total weight of the polypropylene-based thermoplastic polymer material.

The polypropylene-based thermoplastic polymer material may also comprise an olefin homopolymer or copolymer P₂.

Said olefin homopolymer or copolymer P₂ is preferably different from said propylene homopolymer or copolymer P₁.

The olefin of the olefin copolymer P₂ may be chosen from ethylene and an olefin α₃ having the formula CH₂═CH—R², in which R² is a linear or branched alkyl group containing from 1 to 12 carbon atoms.

The olefin α₃ is preferably chosen from the following olefins: propylene, 1-butene, isobutylene, 1-pentene, 4-methyl-1-pentene, 1-hexene, 1-octene, 1-decene, 1-dodecene, and a mixture thereof.

The olefin α₃ of the propylene, 1-hexene or 1-octene type is particularly preferred.

The combination of polymers P₁ and P₂ makes it possible to obtain a thermoplastic polymer material with good mechanical properties, notably in terms of elastic modulus, and good electrical properties.

The olefin homopolymer or copolymer P₂ is preferably an ethylene polymer.

The ethylene polymer preferably comprises at least about 80 mol % of ethylene, particularly preferably at least about 90 mol % of ethylene, and more particularly preferably at least about 95 mol % of ethylene, relative to the total number of moles of the ethylene polymer.

According to a preferred embodiment of the invention, the ethylene polymer is a low-density polyethylene, a linear low-density polyethylene, a medium-density polyethylene, or a high-density polyethylene, and preferably a high-density polyethylene; notably according to the standard ISO 1183A (at a temperature of 23° C.).

The ethylene polymer preferably has an elastic modulus of at least 400 MPa, and particularly preferably of at least 500 MPa.

In the present invention, the elastic modulus or Young's modulus of a polymer (known as the Tensile Modulus) is well known to those skilled in the art, and may be readily determined according to the standard ISO 527-1, -2 (2012). The standard ISO 527 has a first part, noted “ISO 527-1”, and a second part, noted “ISO 527-2” specifying the test conditions relating to the general principles of the first part of the standard ISO 527.

In the present invention, the term “low density” means having a density ranging from about 0.91 to about 0.925 g/cm³, said density being measured according to the standard ISO 1183A (at a temperature of 23° C.).

In the present invention, the term “medium density” means having a density ranging from about 0.926 to about 0.940 g/cm³, said density being measured according to the standard ISO 1183A (at a temperature of 23° C.).

In the present invention, the term “high density” means having a density ranging from 0.941 to 0.965 g/cm³, said density being measured according to the standard ISO 1183A (at a temperature of 23° C.).

According to a preferred embodiment of the invention, the olefin homopolymer or copolymer P₂ represents from about 5% to 50% by weight, and particularly preferably from about 10% to 40% by weight, relative to the total weight of the polypropylene-based thermoplastic polymer material.

According to a particularly preferred embodiment of the invention, the polypropylene-based thermoplastic polymer material comprises two propylene copolymers P₁ such as a homophasic propylene copolymer and a heterophasic propylene copolymer or two different heterophasic propylene copolymers; and an olefin homopolymer or copolymer P₂ such as an ethylene polymer. This combination of propylene copolymers P₁ and an olefin homopolymer or copolymer P₂ allows further improvement of the mechanical properties of the electrically insulating layer, while at the same time ensuring good thermal conductivity.

The thermoplastic polymer material of the polymer composition of the electrically insulating layer of the cable of the invention is preferably heterophasic (i.e. it comprises several phases). The presence of several phases generally results from the mixing of two different polyolefins, such as a mixture of different propylene polymers or a mixture of a propylene polymer and an ethylene polymer.

The polymer composition of the electrically insulating layer of the invention is a thermoplastic polymer composition. It is thus not crosslinkable.

In particular, the polymer composition does not comprise any crosslinking agents, silane couplers, peroxides and/or additives that enable crosslinking. The reason for this is that such agents degrade the polypropylene-based thermoplastic polymer material.

The polymer composition is preferably recyclable.

The polypropylene-based thermoplastic polymer material may represent at least about 50% by weight, preferably at least about 70% by weight, and particularly preferably at least about 80% by weight, relative to the total weight of the polymer composition.

The polymer composition preferably does not comprise any polymers other than those included in the polypropylene-based thermoplastic polymer material.

The polypropylene-based thermoplastic polymer material preferably comprises at least about 50% by weight, preferably at least about 70% by weight, and particularly preferably at least about 80% by weight, of propylene polymer(s), relative to the total weight of the polypropylene-based thermoplastic polymer material.

### The Electrically Insulating Layer

The electrically insulating layer of the cable of the invention is a non-crosslinked layer, in other words a thermoplastic layer.

In the invention, the term “non-crosslinked layer” or “thermoplastic layer” means a layer with a gel content according to the standard ASTM D2765-01 (xylene extraction) of not more than about 30%, preferably not more than about 20%, particularly preferably not more than about 10%, more particularly preferably not more than 5%, and even more particularly preferably 0%.

In one embodiment of the invention, the preferably non-crosslinked electrically insulating layer has a thermal conductivity of at least 0.30 W/m·K at 40° C., preferably at least 0.31 W/m·K at 40° C., particularly preferably at least 0.32 W/m·K at 40° C., more particularly preferably at least 0.33 W/m·K at 40° C., even more particularly preferably at least 0.34 W/m·K at 40° C., and even more particularly preferably at least 0.35 W/m·K at 40° C.

In a particular embodiment, the preferably non-crosslinked electrically insulating layer has a tensile strength (TS) of at least 8.5 MPa, preferably at least about 10 MPa, and particularly preferably at least about 15 MPa, before aging (according to the standard CEI 20-86).

In a particular embodiment, the preferably non-crosslinked electrically insulating layer has an elongation at break (EB) of at least about 250%, preferably at least about 300%, and particularly preferably at least about 350%, before aging (according to the standard CEI 20-86).

In a particular embodiment, the preferably non-crosslinked electrically insulating layer has a tensile strength (TS) of at least 8.5 MPa, preferably at least about 10 MPa, and particularly preferably at least about 15 MPa, after aging (according to the standard CEI 20-86).

In a particular embodiment, the preferably non-crosslinked electrically insulating layer has an elongation at break (EB) of at least about 250%, preferably at least about 300%, and particularly preferably at least about 350%, after aging (according to the standard CEI 20-86).

The tensile strength (TS) and elongation at break (EB) (before or after aging) may be determined according to the standard NF EN 60811-1-1, notably using a machine sold under the reference 3345 by the company Instron.

The aging is generally performed at 135° C. for 240 hours (or 10 days).

The electrically insulating layer of the cable of the invention is preferably a recyclable layer.

The electrically insulating layer of the invention may be a layer that is extruded, notably via processes that are well known to those skilled in the art.

The electrically insulating layer has a thickness that is variable as a function of the type of cable envisaged. In particular, when the cable in accordance with the invention is a medium-voltage cable, the thickness of the electrically insulating layer is typically from about 4 to about 5.5 mm, and more particularly about 4.5 mm. When the cable according to the invention is a high-voltage cable, the thickness of the electrically insulating layer typically ranges from 17 to 18 mm (for voltages of the order of about 150 kV) and up to thicknesses ranging from about 20 to about 25 mm for voltages above 150 kV (high-voltage cables). The abovementioned thicknesses depend on the size of the elongated electrically conductive element.

In the present invention, the term “electrically insulating layer” means a layer having an electrical conductivity which may be not more than 1×10⁻⁸ S/m (siemens per metre), preferably not more than 1×10⁻⁹ S/m, and particularly preferably not more than 1×⁻¹⁰ S/m, measured at 25° C. in DC.

The electrically insulating layer of the invention may comprise at least the polypropylene-based thermoplastic polymer material, at least the first thermally conductive inorganic filler, at least the second thermally conductive inorganic filler and the dielectric liquid, the abovementioned ingredients being as defined in the invention.

The proportions of the various ingredients in the electrically insulating layer may be identical to those as described in the invention for these same ingredients in the polymer composition.

The cable of the invention relates more particularly to the field of electric cables operating in direct current (DC) or alternating current (AC).

### The Cable

The electrically insulating layer of the invention may surround the elongated electrically conductive element.

The elongated electrically conductive element is preferably positioned at the center of the cable.

The elongated electrically conductive element may be a single-body conductor, for instance a metal wire, or a multi-body conductor such as a plurality of twisted or untwisted metal wires.

The elongated electrically conductive element may be made of aluminum, aluminum alloy, copper, copper alloy, or a combination thereof.

According to a preferred embodiment of the invention, the electric cable comprises:
at least one semiconductive layer surrounding the elongated electrically conductive element, and
an electrically insulating layer as defined in the invention.

More particularly, the electrically insulating layer has a lower electrical conductivity than that of the semiconductive layer. More particularly, the electrical conductivity of the semiconductive layer may be at least 10 times greater than the electrical conductivity of the electrically insulating layer, preferably at least 100 times greater than the electrical conductivity of the electrically insulating layer, and particularly preferably at least 1000 times greater than the electrical conductivity of the electrically insulating layer.

The semiconductive layer may surround the electrically insulating layer. The semiconductive layer may then be an outer semiconductive layer.

The electrically insulating layer may surround the semiconductive layer. The semiconductive layer may then be an inner semiconductive layer.

The semiconductive layer is preferably an inner semiconductive layer.

The electric cable of the invention may also comprise another semiconductive layer.

Thus, in this embodiment, the cable of the invention may comprise:
at least one elongated electrically conductive element, preferably positioned at the center of the cable,
a first semiconductive layer surrounding the elongated electrically conductive element,
an electrically insulating layer surrounding the first semiconductive layer, and
a second semiconductive layer surrounding the electrically insulating layer,
the electrically insulating layer being as defined in the invention.

In the present invention, the term “semiconductive layer” means a layer whose electrical conductivity may be strictly greater than 1×10⁻⁸ S/m (siemens per metre), preferably at least 1×10⁻³ S/m, and may preferably be less than 1×10³ S/m, measured at 25° C. in DC.

In a particular embodiment, the first semiconductive layer, the electrically insulating layer and the second semiconductive layer constitute a three-layer insulation. In other words, the electrically insulating layer is in direct physical contact with the first semiconductive layer, and the second semiconductive layer is in direct physical contact with the electrically insulating layer.

The first semiconductive layer (or, respectively, the second semiconductive layer) is preferably obtained from a polymer composition comprising at least one polypropylene-based thermoplastic polymer material as defined in the invention, and optionally at least one electrically conductive filler.

The electrically conductive filler preferably represents an amount sufficient for the layer to be semiconductive.

Preferably, the polymer composition may comprise at least about 6% by weight of electrically conductive filler, preferably at least about 10% by weight of electrically conductive filler, preferentially at least about 15% by weight of electrically conductive filler, and even more preferentially at least about 25% by weight of electrically conductive filler, relative to the total weight of the polymer composition.

The polymer composition may comprise not more than about 45% by weight of electrically conductive filler, and preferably not more than about 40% by weight of electrically conductive filler, relative to the total weight of the polymer composition.

The electrically conductive filler may be carbon black.

The first semiconductive layer (or, respectively, the second semiconductive layer) is preferably a thermoplastic layer or a non-crosslinked layer.

The cable may also comprise an outer protective sheath surrounding the electrically insulating layer (or the second semiconductive layer, if present).

The outer protective sheath may be in direct physical contact with the electrically insulating layer (or the second semiconductive layer, if present).

The outer protective sheath may be an electrically insulating sheath.

The electric cable may also comprise an electrical shield (e.g. metallic) surrounding the second semiconductive layer. In this case, the electrically insulating sheath surrounds said electrical shield and the electrical shield is between the electrically insulating sheath and the second semiconductive layer.

This metallic shield may be a “wire” shield composed of a set of copper or aluminum conductors arranged around and along the second semiconductive layer, a “ribbon” shield composed of one or more conductive copper or aluminum metal ribbons which may be laid in a helix around the second semiconductive layer, or a conductive aluminum metal ribbon laid longitudinally around the second semiconductive layer and rendered leaktight by means of adhesive in the overlapping areas of parts of said ribbon, or a “leaktight” shield of the metal tube type, possibly composed of lead or lead alloy and surrounding the second semiconductive layer. This last type of shield can notably act as a barrier to moisture, which has a tendency to penetrate the electric cable in the radial direction.

The metal shield of the electric cable of the invention may comprise a “wire shield” and a “leaktight shield” or a “wire shield” and a “ribbon shield”.

All the types of metal shield may act as earthing for the electric cable and may thus transport fault currents, for example in the case of short-circuiting in the network concerned.

Other layers, such as layers which swell in the presence of moisture, may be added between the second semiconductive layer and the metal shield, these layers providing the longitudinal leaktightness to water of the electric cable.

### BRIEF DESCRIPTION OF THE DRAWINGS

FIG. 1 represents a cable in accordance with the invention.

For the sake of clarity, only the elements that are essential for the understanding of the invention have been represented schematically, and are not to scale.

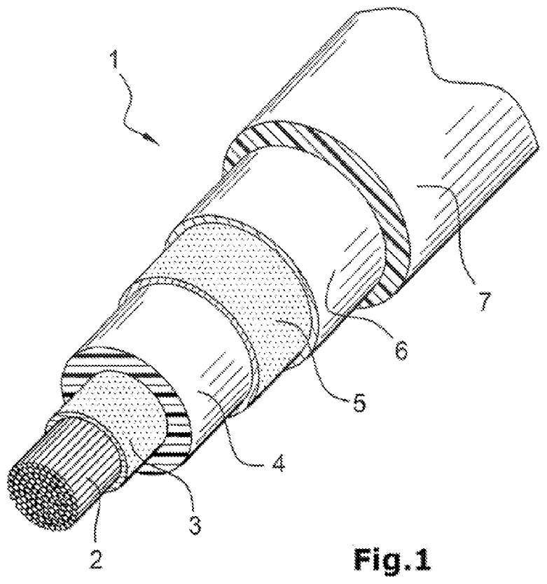

In FIG. 1, the medium-voltage or high-voltage electric cable 1 in accordance with the invention, illustrated in FIG. 1, comprises a central elongated electrically conductive element 2, notably made of copper or aluminum. The electric cable 1 also comprises several layers arranged successively and coaxially around this central elongated electrically conductive element 2, namely: a first semiconductive layer 3, referred to as the “inner semiconductive layer”, an electrically insulating layer 4, a second semiconductive layer 5, referred to as the “outer semiconductive layer”, an earthing and/or protective metal shield 6, and an outer protective sheath 7.

The electrically insulating layer 4 is a non-crosslinked extruded layer obtained from the polymer composition as defined in the invention.

The semiconductive layers 3 and 5 are extruded thermoplastic layers (i.e. non-crosslinked layers).

The presence of the metal shield 6 and of the outer protective sheath 7 is preferential, but not essential, this cable structure being, per se, well known to those skilled in the art.

### EXAMPLE

### Polymer Compositions

A layer in accordance with the invention, i.e. obtained from a polymer composition comprising at least one polypropylene-based thermoplastic polymer material, at least one dielectric liquid, at least a first thermally conductive inorganic filler and at least a second thermally conductive inorganic filler was prepared.

Table 1 below collates the amounts of the compounds present in the polymer composition in accordance with the invention which are expressed as weight percentages, relative to the total weight of the polymer composition.

TABLE 1

| Ingredients of | Comparative | Comparative | Comparative | Inventive | Inventive |
|---|---|---|---|---|---|
| the polymer | composition | composition | composition | composition | composition |
| composition | C1 | C2 | C3 | I1 | I2 |
| Heterophasic | 35% | 29% | 29% | 29% | 29% |
| propylene | | | | | |
| copolymer | | | | | |
| Statistical | 35% | 29% | 29% | 29% | 29% |
| propylene | | | | | |
| copolymer | | | | | |
| High-density | 25.8% | 21.5% | 21.5% | 21.5% | 21.5% |
| polyethylene | | | | | |
| First thermally | 0% | 15% | 0% | 5% | 10% |
| conductive | | | | | |
| inorganic filler | | | | | |
| Second | 0% | 0% | 15% | 10% | 5% |
| thermally | | | | | |
| conductive | | | | | |
| inorganic filler | | | | | |
| Dielectric liquid | 3.7% | 4.5% | 4.5% | 4.5% | 4.5% |
| Antioxidant | 0.5% | 1.0% | 1.0% | 1.0% | 1.0% |

The origin of the compounds of Table 1 is as follows:
statistical propylene copolymer sold by the company Total Petrochemicals under the reference PPR3221;
heterophasic propylene copolymer sold by the company Basell Polyolefins under the reference Adflex® Q 200 F;
high-density polyethylene sold under the trade name Eltex® A4009 MFN1325 by the company Ineos and whose density is 0.960 g/cm³ according to the standard ISO 1183A at a temperature of 23° C. (MFI=0.9);
first thermally conductive inorganic filler: calcined alumina sold under the trade name Timal 17 by the company Univar, having a mean particle size D50 of 400 nm, a specific surface area according to the BET method of 8 m²/g, and being in the form of particle aggregates;
second thermally conductive inorganic filler: sepiolite (hydrated magnesium silicate) sold under the trade name Pangel S9 by the company Tolsa Advanced Materials, having a fibrous structure (acicular) and thus an elongated shape (fibers with a length of between 200 and 2000 nm, a width of between 10 and 30 nm and a thickness of between 5 and 10 nm), and having a specific surface area according to the BET method of 300 m²/g;
antioxidant sold by the company Ciba under the reference Irganox® B 225 comprising an equimolar mixture of Irgafos® 168 and Irganox® 1010; and
dielectric liquid comprising 95% by weight of an oil sold by the company Nynas under the reference BNS 28, and 5% by weight of benzophenone.

### Preparation of the Non-Crosslinked Layer

The following constituents: mineral oil, antioxidant and benzophenone of the polymer composition referenced in Table 1, are measured out and mixed with stirring at about 75° C., so as to form a dielectric liquid.

The dielectric liquid is then mixed with the following constituents: heterophasic propylene copolymer, statistical propylene copolymer, high-density polyethylene of the polymer composition referenced in Table 1, in a container. Then, the resulting mixture, the first thermally conductive inorganic filler and the second inorganic filler are mixed using a Berstorff twin-screw extruder at a temperature of about 145 to 180° C. and then melted at about 200° C. (screw speed: 80 rpm).

The resulting homogenized molten mixture is then formed into granules.

The granules are then hot-pressed to form a layer.

The polymer composition I1 and the polymer composition I2 were thus prepared in the form of an 8 mm thick layer for performing thermal conductivity measurements.

The same process is used to form the comparative polymer compositions C1 to C3.

The thermal conductivity tests were performed on the materials according to the well known Transient Plane Source or TPS method using a machine sold under the reference Hot Disk TPS 2500S by the company Thermoconcept.

The results corresponding to each of these tests are given in Table 2 below:

TABLE 2

| Properties | C1 | C2 | C3 | I1 | I2 |
|---|---|---|---|---|---|
| Thermal conductivity at | 0.271 | 0.308 | 0.308 | 0.318 | 0.321 |
| 40° C. (W/m · K) | | | | | |

Taken together, these results show that incorporating two thermally conductive inorganic fillers of different morphologies as defined in the invention into a polypropylene matrix improves thermal conductivity properties.

1. An electric cable comprising:
at least one elongated electrically conductive element and at least one electrically insulating layer obtained from a polymer composition, wherein the polymer composition comprises
at least one thermoplastic polymer material based on polypropylene,
at least one dielectric liquid,
at least a first thermally conductive inorganic filler having a morphology M1 and
at least a second thermally conductive inorganic filler having a morphology M2 different from the morphology M1 of the first thermally conductive inorganic filler.

2. The electric cable as claimed in claim 1, wherein the first inorganic filler represents not more than 40% by weight, relative to the total weight of the polymer composition, and the second inorganic filler represents not more than 40% by weight, relative to the total weight of the polymer composition.

3. The electric cable as claimed in claim 1, wherein the first inorganic filler represents at least 1% by weight, relative to the total weight of the polymer composition, and the second inorganic filler represents at least 1% by weight, relative to the total weight of the polymer composition.

4. The electric cable as claimed in claim 1, wherein the first thermally conductive inorganic filler is chosen from silicates, boron nitride, carbonates and metal oxides, and the second thermally conductive inorganic filler is chosen from silicates, boron nitride, carbonates and metal oxides.

5. The electric cable as claimed in claim 1, wherein the second thermally conductive inorganic filler is different from the first thermally conductive inorganic filler, in that the morphology is represented by at least one of the parameters chosen from the size, the shape, and the specific surface area.

6. The electric cable as claimed in claim 1, wherein the first thermally conductive inorganic filler is in the form of particles having a size distribution D50 of not more than 1.5 μm, and the second thermally conductive inorganic filler is in the form of particles having a size distribution D50 ranging from 1 to 900 nm, and wherein the D50 of the first thermally conductive inorganic filler minus the D50 of the second thermally conductive inorganic filler is greater than or equal to 100 nm.

7. The electric cable as claimed in claim 1, wherein the first and second thermally conductive inorganic fillers have the same chemical composition.

8. The electric cable as claimed in claim 1, wherein the first thermally conductive inorganic filler has a specific surface area according to the BET method ranging from 1 to 300 m²/g, and the second thermally conductive inorganic filler has a specific surface area according to the BET method ranging from 80 to 500 m²/g, and wherein the specific surface area of the second thermally conductive inorganic filler minus the specific surface area of the first thermally conductive inorganic filler is greater than or equal to 100 m²/g.

9. The electric cable as claimed in claim 1, wherein the first and second thermally conductive inorganic fillers have different shapes chosen from spherical, particle aggregate, elongated, flat, and flat and elongated shapes.

10. The electric cable as claimed in claim 1, wherein the first thermally conductive inorganic filler is in the form of particles having a form factor L₁/D_{A1} or L₁/D_{B1} of not more than 3, and the second thermally conductive inorganic filler is in the form of particles having a form factor L₂/D_{A2} or L₂/D_{B2} of at least 4,
L₁ being the length of the first thermally conductive inorganic filler particles, L₂ the length of the second thermally conductive inorganic filler particles, (D_{A1}, D_{B1}) the dimensions of the first thermally conductive inorganic filler particles orthogonal to the length L₁, (D_{A2}, D_{B2}) the dimensions of the second thermally conductive inorganic filler particles orthogonal to the length L₂.

11. The electric cable as claimed in claim 1, wherein the mass ratio of first thermally conductive inorganic filler to second thermally conductive inorganic filler ranges from 0.1 to 9.

12. The electric cable as claimed in claim 1, wherein the polypropylene-based thermoplastic polymer material comprises a copolymer of propylene and of ethylene P₁.

13. The electric cable as claimed in claim 1, wherein the polypropylene-based thermoplastic polymer material comprises a propylene copolymer P₁ chosen from a homophasic propylene copolymer and a heterophasic propylene copolymer.

14. The electric cable as claimed in claim 1, wherein the electrically insulating layer is a non-crosslinked layer.

15. The electric cable as claimed in claim 1, wherein said electric cable comprises:
at least one semiconductive layer surrounding the elongated electrically conductive element, and
said at least one electrically insulating layer surrounding the elongated electrically conductive element.
